(19) United States
(12) Patent Application Publication
(10) Pub. No.: US 2026/0156003 A1
(43) Pub. Date: Jun. 4, 2026

(54) BISTABLE WEAK PUF CIRCUIT WITH AUTONOMOUS STABILITY SCREENING FUNCTION

(71) Applicant: Wenzhou University, Zhejiang (CN)

(72) Inventors: Gang LI, Zhejiang (CN); Pengjun WANG, Zhejiang (CN); Bo CHEN, Zhejiang (CN); Hui Li, Zhejiang (CN); Junjie Zhou, Zhejiang (CN)

(73) Assignee: Wenzhou University, Zhejiang (CN)

(21) Appl. No.: 19/026,593

(22) Filed: Jan. 17, 2025

(30) Foreign Application Priority Data
Dec. 2, 2024 (CN) 202411745832.6

(51) Int. Cl. H04L 9/32

(52) U.S. Cl. CPC H04L 9/3278

(57) ABSTRACT

A bistable weak PUF circuit with an autonomous stability screening function is provided. The bistable weak PUF circuit includes a decoder, a timing circuit, and a PUF core circuit is provided. The PUF core circuit realizes stable bit screening by connecting two screening levels. When the two screening levels connected to the PUF core circuit are equal, the PUF core circuit generates a W-bit original PUF response in one clock cycle under the control of an m-bit word line level signal output thereto by the decoder. Then, the m-bit word line level signal received by the PUF core circuit is kept unchanged, one of the two screening levels connected to the PUF core circuit is kept unchanged, and the other is reduced by a certain amplitude, and two W-bit screened PUF responses are obtained after the screening levels are exchanged.

### CROSS-REFERENCE TO RELATED APPLICATION

This application claims the priority benefit of China application serial no. 202411745832.6, filed on Dec. 2, 2024. The entirety of the above-mentioned patent application is hereby incorporated by reference herein and made a part of this specification.

### Technical Field

The present disclosure relates to a weak PUF circuit and, in particular, to a bistable weak PUF circuit with an autonomous stability screening function.

### Description of Related Art

Physical Unclonable Function (PUF) provides a new method for generating chip fingerprints, which can be used to generate characteristic keys with randomness, uniqueness and tamper-proof characteristics, and is very suitable for the field of Internet of Things (IoT). PUF captures random process deviations in the chip manufacturing process, converts process deviations into physical deviations such as voltage, current and delay, and generates output responses by comparing the deviation size through an arbitrator. According to the different capabilities of generating challenge-response pairs (CRPs), PUF circuits can be roughly divided into two categories: weak PUF circuits and strong PUF circuits. For weak PUF circuits, usually a PUF unit in the PUF array generates only one PUF response. Since its hardware entropy source is not reused, all the generated PUF responses are independent of each other. For strong PUF circuits, the PUF units in the PUF array are interrelated, and a PUF unit can generate multiple PUF responses. Since its hardware entropy source reuses, there is inevitably correlation between the generated PUF responses. Therefore, compared with strong PUF circuits, weak PUF circuits have better resistance to model attacks and machine learning attacks, and are mainly used for key generation in information systems. However, since a PUF unit in a weak PUF circuit has only one corresponding PUF response, and the PUF response is easily affected by changes in environmental conditions such as temperature, supply voltage, and noise, and flips, and the stability deteriorates, resulting in poor stability of the weak PUF circuit.

In response to the stability problem of the weak PUF circuit, some researchers have proposed some detection methods to detect the unstable bits of the PUF responses, thereby improving the stability of the weak PUF circuit. For example, with reference to “An SRAM-Based PUF With a Capacitive Digital Preselection for a 1E-9 Key Error Probability [J], IEEE Transactions on Circuits and Systems I: Regular Papers, 2020, vol. 67, no. 12, pp. 4855-4868”, a capacitor tilt stabilization technology is provided for the metastable weak PUF circuit to detect the stability of the PUF response. The capacitor tilt stabilization technology avoids the flipping of the PUF response by adding a capacitor with an adjustable capacitance value to a cross-coupled inverter of the PUF unit of the weak PUF circuit, thereby improving the stability of the PUF response. However, the capacitor area added by the capacitor tilt stabilization technology in the weak PUF circuit is much larger than the area of the original weak PUF circuit, and an additional switch is required for each capacitor to control whether the capacitor is connected to the weak PUF circuit, resulting in a significant increase in the hardware overhead of the weak PUF circuit and high detection costs.

With reference to “High-Density and Low-Power PUF Designs in 5 nm Achieving 23× and 39× BER Reduction After Unstable Bit Detection and Masking [C], 2024 IEEE International Solid-State Circuits Conference (ISSCC), San Francisco, CA, USA, 2024, pp. 302-304”, provided was a technology for detecting possible unstable bits (i.e., unstable PUF responses) in a weak PUF circuit by injecting current offset using a high-resolution digital-to-analog converter (DAC), thereby filtering out unstable PUF responses. However, this technology requires an additional high-resolution digital-to-analog converter in the weak PUF circuit. The high-resolution digital-to-analog converter has a large area, resulting in a feature size of up to 3920F² in the weak PUF circuit. The hardware overhead is large and the detection cost is high.

With reference to “A 6T-SRAM-Based Physically-Unclonable-Function With Low BER Through Automated Maximum Mismatch Detection [J], IEEE Transactions on Circuits and Systems II: Express Briefs, 2024, vol. 71, no. 7, pp. 3493-3497”, provided was a 6T-SRAM PUF, which uses maximum mismatch detection technology to detect unstable responses by identifying and selecting adjacent PUF units with the highest mismatch in four different configurations. However, additional storage space is required to store different configuration information corresponding to each PUF unit, and hardware resource overhead and detection cost are also increased.

### SUMMARY

The technical problem to be solved by the present disclosure is to provide a bistable weak PUF circuit with an autonomous stability screening function, which has high stability, low hardware overhead and low detection cost.

The technical solution adopted to solve the problem stated above is: a bistable weak PUF circuit with an autonomous stability screening function, comprising: a decoder, a timing circuit and a PUF core circuit, wherein the decoder is used to access an n-bit challenge signal C₁-Cₙ, and perform a decoding operation on the n-bit challenge signal C₁-Cₙ to obtain an m-bit word line level signal WL₁-WLₘ and output the m-bit word line level signal WL₁-WLₘ to the PUF core circuit, where n is an integer greater than or equal to 1, and m=2ⁿ; the timing circuit is used to access a clock signal CLK and an enable signal CEN, perform an AND operation on the clock signal CLK and the enable signal CEN to obtain a clock signal AEN for controlling the working timing of the decoder and output the clock signal AEN to the decoder, and to delay and invert the clock signal AEN and perform an NAND operation on the clock signal AEN to obtain a clock signal PRE for controlling the working timing of the PUF core circuit and output the clock signal PRE to the PUF core circuit; the PUF core circuit is used to generate a W-bit PUF response in each clock cycle of the clock signal PRE under the control of the m-bit word line level signal output by the decoder, where W is an integer greater than or equal to 1; the PUF core circuit has an autonomous stable bit screening function, and the PUF core circuit realizes stable bit screening by connecting two screening levels; when the two screening levels connected to the PUF core circuit are equal, the PUF core circuit generates a W-bit PUF response in one clock cycle of the clock signal PRE under the control of the m-bit word line level signal output by the decoder as an original PUF response of the clock cycle; then, the m-bit word line level signal received by the PUF core circuit is kept unchanged, one of the two screening levels connected to the PUF core circuit is kept unchanged, and the other is reduced by a certain amplitude, and the W-bit PUF response generated within a clock cycle of the clock signal PRE is used as a first screened PUF response; then, the two screening levels are exchanged, the W-bit PUF response generated within one clock cycle of the clock signal PRE is used as a second screened PUF response; the first screened PUF response and the second screened PUF response are XORed with each other to obtain a W-bit stability mark value; if the value of a bit in the W-bit stability mark value is 1, it is considered that the response value of this bit in the original PUF response under the current challenge signal is an unstable response.

Compared with the prior art, the present disclosure has the following advantages: the PUF core circuit is connected to two screening levels to perform unstable response detection; when the PUF core circuit generates a W-bit PUF response within a certain clock cycle, the m-bit word line level signal received is kept unchanged, and two equal screening levels are connected firstly to generate an original PUF response, and then two unequal screening levels are connected to generate two screened PUF responses; when the two screening levels are not equal, the unstable response value in the original PUF response will flip if there is an unstable response in the original PUF response, the unstable response will flip, so that the corresponding bit value in the W-bit stability mark value obtained after the XOR operation of the two screened PUF responses will be 1and in this case, if the value of a certain bit in the W-bit stability mark value is 1, it is considered that the response value of this bit in the original PUF response under the current challenge signal is an unstable response; if there is no unstable response in the original PUF response, no flipping will occur at this time, and all bits of the W-bit stability mark value will be completely 0. Therefore, the present disclosure can screen out unstable responses with high stability, and can achieve unstable screening by only connecting two screening levels and causing the two screening levels to be equal and unequal, without the need for additional devices, with low hardware overhead and low detection cost.

Further, the decoder has n challenge signal input terminals, an clock signal input terminal and m output terminals; the timing circuit has two input terminals and two output terminals, the two input terminals are respectively designated as first input terminal and second input terminal, the two output terminals are respectively designated as first output terminal and second output terminal, the PUF core circuit has a power supply terminal, a ground terminal, m word line level signal input terminals, one clock signal input terminal, two screening level input terminals and W output terminals, the n challenge signal input terminals of the decoder are used to access the n-bit challenge signal C₁-Cₙ, the m output terminals of the decoder are used to output the m-bit word line level signal, the m output terminals of the decoder are connected one-to-one with the m word line level signal input terminals of the PUF core circuit, the first input terminal of the timing circuit accesses the enable signal CEN, the second input terminal is connected to the clock signal CLK, the first output terminal of the timing circuit is connected to the clock signal input terminal of the decoder, the first output terminal of the timing circuit outputs the clock signal AEN, the second output terminal of the timing circuit is connected to the clock signal input terminal of the PUF core circuit, the second output terminal of the timing circuit outputs the clock signal PRE, the power supply terminal of the PUF core circuit is used to access the working supply VDD, the ground terminal of the PUF core circuit is used to connect to the ground voltage VSS, the W output terminals of the PUF core circuit are used to output W-bit PUF responses Z₁-Z_{W}, and the two screening level input terminals of the PUF core circuit are respectively connected to the screening levels V_{L} and V_{R}.

Further, the timing circuit comprises a D flip-flop, twenty-one inverters, a two-input AND gate and a first two-input NAND gate; the D flip-flop has an input terminal, a clock terminal and an output terminal; the two-input AND gate has a first input terminal, a second input terminal and an output terminal; the first two-input NAND gate has a first input terminal, a second input terminal and an output terminal; the input terminal of the D flip-flop is connected to the first input terminal of the timing circuit, the clock terminal of the D flip-flop and the second input terminal of the two-input AND gate, and the connection terminal thereof is the second input terminal of the timing circuit; the output terminal of the D flip-flop is connected to the first input terminal of the two-input AND gate; the output terminal of the two-input AND gate, the input terminal of the inverter 1 and the second input terminal of the first two-input NAND gate are connected, and the connection terminal thereof is the first output terminal of the timing circuit; the output terminal of the inverter k is connected to the input terminal of the inverter k+1 (k=1, 2, . . . , 20), the output terminal of the inverter 21 is connected to the first input terminal of the first two-input NAND gate, and the output terminal of the first two-input NAND gate is the second output terminal of the timing circuit.

Further, the PUF core circuit comprises W PUF unit arrays and W latches; each PUF unit array has a power supply terminal, a ground terminal, a clock signal input terminal, m word line level signal input terminals, two screening level input terminals and two output terminals, the two screening level input terminals are respectively designated as first screening level input terminal and second screening level input terminal, and the two output terminals are respectively designated as first output terminal and second output terminal; each latch has two input terminals and one output terminal, the two input terminals are respectively designated as first input terminal and second input terminal; the power supply terminals of the W PUF unit arrays are connected, and the connection terminal thereof is the power supply terminal of the PUF core circuit; the ground terminals of the W PUF unit arrays are connected, and the connection terminal thereof is the ground terminal of the PUF core circuit; the first screening level input terminals of the W PUF unit arrays are connected, and the connection terminal is the first screening level input terminal of the PUF core circuit; the second screening level input terminals of the W PUF unit arrays are connected, and the connection terminal thereof is the second screening level input terminal of the PUF core circuit; the clock signal input terminals of the W PUF unit arrays are connected, and the connection terminal thereof is the clock signal input terminal of the PUF core circuit; the word line level signal input terminals of the W PUF unit arrays are connected, and the connection terminal thereof is the word line level signal input terminal i of the PUF core circuit (i=1, 2, . . . , m); the first output terminal of the PUF unit array b is connected to the first input terminal of the latch b, and the second output terminal of the PUF unit array b is connected to the second input terminal of the latch b (b=1, 2, . . . , W), and the output terminals of the W latches are the W output terminals of the PUF core circuit; each of the PUF unit arrays comprises one decision unit and m PUF units, each PUF unit has one word line level signal input terminal, two screening level input terminals and four output terminals, the four output terminals are respectively designated as first output terminal, second output terminal, third output terminal and fourth output terminal, and the two screening level input terminals are respectively designated as first screening level input terminal and second screening level input terminal; the decision unit has a power supply terminal, a ground terminal, a clock signal input terminal, two input terminals and two output terminals, the two input terminals are respectively designated as first input terminal and second input terminal, and the two output terminals are respectively designated as first output terminal and second output terminal; the word line level signal input terminals of the m PUF units are the m word line level signal input terminals of the PUF unit array, the first screening level input terminals of the m PUF units are connected, and the connection terminal thereof is the first screening level input terminal of the PUF unit array; the second screening level input terminals of the m PUF units are connected, and the connection terminal thereof is the second screening level input terminal of the PUF unit array; the power supply terminal of the decision unit is the power supply terminal of the PUF unit array, the ground terminal of the decision unit is the ground terminal of the PUF unit array, the clock signal input terminal of the decision unit is the clock signal input terminal of the PUF unit array, the first input terminal of the decision unit is connected to the third output terminal of the m PUF units, the second input terminal of the decision unit is connected to the fourth output terminal of the m PUF units, the first output terminal of the decision unit is connected to the first output terminals of the m PUF units, and the connection terminal thereof is the first output terminal of the PUF unit array; the second output terminal of the decision unit is connected to the second output terminals of the m PUF units, and the connection terminal thereof is the second output terminal of the PUF unit array.

Further, the decision unit comprises a first MOS transistor, a second MOS transistor, a third MOS transistor, a fourth MOS transistor, a fifth MOS transistor and a sixth MOS transistor; the first MOS transistor, the second MOS transistor, the third MOS transistor and the fourth MOS transistor are PMOS transistors; the fifth MOS transistor and the sixth MOS transistor are NMOS transistors; a source of the first MOS transistor, a source of the second MOS transistor, a source of the third MOS transistor and a source of the fourth MOS transistor are connected, and the connection terminal thereof is the power supply terminal of the decision unit; a source of the fifth MOS transistor is connected to a source of the sixth MOS transistor, and the connection terminal thereof is the ground terminal of the decision unit, a gate of the third MOS transistor is connected to a gate of the fourth MOS transistor, and the connection terminal thereof is the clock signal input terminal of the decision unit; a drain of the first MOS transistor, a drain of the third MOS transistor, a gate of the second MOS transistor and a gate of the sixth MOS transistor are connected, and the connection terminal thereof is the first output terminal of the decision unit; a drain of the second MOS transistor, a drain of the fourth MOS transistor, a gate of the first MOS transistor and a gate of the fifth MOS transistor are connected, and the connection terminal thereof is the second output terminal of the decision unit; a drain of the fifth MOS transistor is the first input terminal of the decision unit, and a drain of the sixth MOS transistor is the second input terminal of the decision unit.

Further, each PUF unit comprises a seventh MOS transistor, an eighth NMOS transistor, a ninth MOS transistor and a tenth MOS transistor, wherein the seventh MOS transistor, the eighth NMOS transistor, the ninth MOS transistor and the tenth MOS transistor are NMOS transistors; a drain of the seventh MOS transistor is the first output terminal of the PUF unit, a drain of the eighth MOS transistor is the second output terminal of the PUF unit, a drain of the ninth MOS transistor is the third output terminal of the PUF unit, a drain of the tenth MOS transistor is the fourth output terminal of the PUF unit, a source of the seventh MOS transistor is connected to a source of the ninth MOS transistor, a source of the eighth MOS transistor is connected to a source of the tenth MOS transistor, a gate of the seventh MOS transistor is connected to a gate of the eighth MOS transistor, and the connection terminal thereof is the word line level signal input terminal of the PUF unit; a gate of the ninth MOS transistor is the first screening level input terminal of the PUF unit, and a gate of the tenth MOS transistor is the second screening level input terminal of the PUF unit.

Further, each of the latches comprises two NAND gates, each of the NAND gates has a first input terminal, a second input terminal and an output terminal, and the two NAND gates are respectively designated as first NAND gate and second NAND gate; the first input terminal of the first NAND gate is the first input terminal of the latch, the first input terminal of the second NAND gate is the second input terminal of the latch, the second input terminal of the first NAND gate is connected to the output terminal of the second NAND gate, the second input terminal of the second NAND gate is connected to the output terminal of the first NAND gate, and the connection terminal thereof is the output terminal of the latch.

### BRIEF DESCRIPTION OF THE DRAWINGS

FIG. 1 is an overall structural diagram of a bistable weak PUF circuit with an autonomous stability screening function according to the present disclosure.

FIG. 2 is a circuit diagram of a timing circuit of the bistable weak PUF circuit with an autonomous stability screening function according to the present disclosure.

FIG. 3 is a circuit diagram of a PUF core circuit of the bistable weak PUF circuit with an autonomous stability screening function according to the present disclosure.

FIG. 4 is a circuit diagram of a PUF unit array of the bistable weak PUF circuit with an autonomous stability screening function according to the present disclosure.

FIG. 5 is a circuit diagram of a decision unit of the bistable weak PUF circuit with an autonomous stability screening function according to the present disclosure.

FIG. 6 is a circuit diagram of a PUF unit of the bistable weak PUF circuit with an autonomous stability screening function according to the present disclosure.

FIG. 7 is a circuit diagram of a latch of the bistable weak PUF circuit with an autonomous stability screening function according to the present disclosure.

FIG. 8 is a layout of the bistable weak PUF circuit with an autonomous stability screening function according to the present disclosure.

FIG. 9 is a grayscale image of PUF responses of the bistable weak PUF circuit with an autonomous stability screening function according to the present disclosure.

FIG. 10 is an average grayscale image of PUF responses of the bistable weak PUF circuit with an autonomous stability screening function according to the present disclosure.

FIG. 11 is a simulation diagram of the normalized inter-chip Hamming distance and intra-chip Hamming distance of the bistable weak PUF circuit with an autonomous stability screening function according to the present disclosure.

FIG. 12 shows the unstable bit proportion of PUF responses of the bistable weak PUF circuit with an autonomous stability screening function according to the present disclosure.

FIG. 13 shows the unstable bit proportion of PUF responses of the bistable weak PUF circuit with an autonomous stability screening function according to the present disclosure after 5 mV composite screening.

FIG. 14 shows the unstable bit proportion of PUF responses of the bistable weak PUF circuit with an autonomous stability screening function according to the present disclosure after 10 mV composite screening.

FIG. 15 shows the unstable bit proportion of PUF responses of the bistable weak PUF circuit with an autonomous stability screening function according to the present disclosure after 15 mV composite screening.

FIG. 16 shows the unstable bit proportion of PUF responses of the bistable weak PUF circuit with an autonomous stability screening function according to the present disclosure after 20 mV composite screening.

FIG. 17 shows the unstable bit proportion of PUF responses of the bistable weak PUF circuit with an autonomous stability screening function according to the present disclosure after composite screening at different screening levels.

### DESCRIPTION OF THE EMBODIMENTS

The present disclosure is further described below in conjunction with accompanying drawings and embodiments.

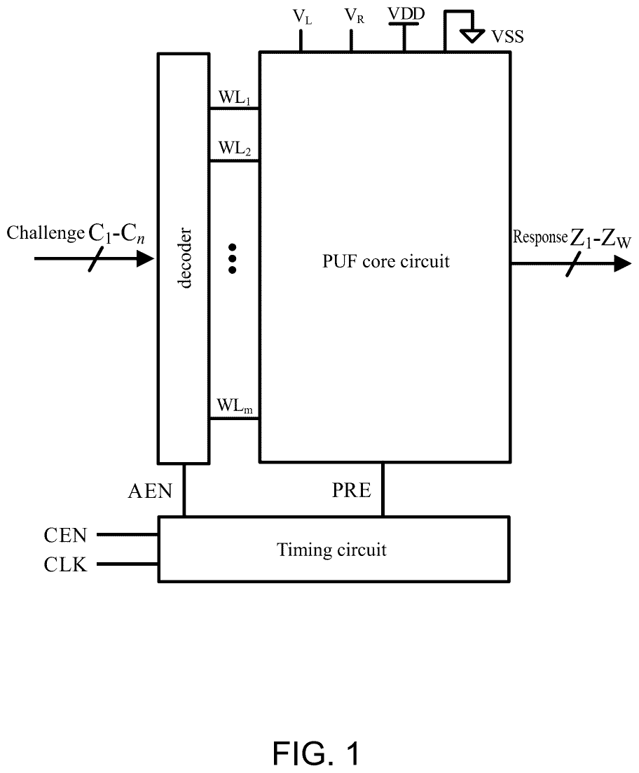

Embodiment 1: As shown in FIG. 1, a bistable weak PUF circuit with an autonomous stability screening function comprises a decoder, a timing circuit and a PUF core circuit, wherein the decoder is used to access an n-bit challenge signal C₁-Cₙ, and perform a decoding operation on the n-bit challenge signal C₁-Cₙ to obtain an m-bit word line level signal WL₁-WLₘ and output the m-bit word line level signal WL₁-WLₘ to the PUF core circuit, where n is an integer greater than or equal to 1, and m=2ⁿ; the timing circuit is used to access a clock signal CLK and an enable signal CEN, perform an AND operation on the clock signal CLK and the enable signal CEN to obtain a clock signal AEN for controlling the working timing of the decoder and output the clock signal AEN to the decoder, and to delay and invert the clock signal AEN and perform an NAND operation on the clock signal AEN to obtain a clock signal PRE for controlling the working timing of the PUF core circuit and output the clock signal PRE to the PUF core circuit; the PUF core circuit is used to generate a W-bit PUF response in each clock cycle of the clock signal PRE under the control of the m-bit word line level signal output by the decoder, where W is an integer greater than or equal to 1; the PUF core circuit has an autonomous stable bit screening function, and the PUF core circuit realizes stable bit screening by connecting two screening levels; when the two screening levels connected to the PUF core circuit are equal, the PUF core circuit generates a W-bit PUF response in one clock cycle of the clock signal PRE under the control of the m-bit word line level signal output by the decoder as an original PUF response of the clock cycle; then, the m-bit word line level signal received by the PUF core circuit is kept unchanged, one of the two screening levels connected to the PUF core circuit is kept unchanged, and the other is reduced by a certain amplitude, and the W-bit PUF response generated within a clock cycle of the clock signal PRE is used as a first screened PUF response; then, the two screening levels are exchanged, the W-bit PUF response generated within one clock cycle of the clock signal PRE is used as a second screened PUF response; the first screened PUF response and the second screened PUF response are XORed with each other to obtain a W-bit stability mark value; if the value of a bit in the W-bit stability mark value is 1, it is considered that the response value of this bit in the original PUF response under the current challenge signal is an unstable response. In this embodiment, the decoder has n challenge signal input terminals, an clock signal input terminal and m output terminals; the timing circuit has two input terminals and two output terminals, the two input terminals are respectively designated as first input terminal and second input terminal, the two output terminals are respectively designated as first output terminal and second output terminal, the PUF core circuit has a power supply terminal, a ground terminal, m word line level signal input terminals, one clock signal input terminal, two screening level input terminals and W output terminals, the n challenge signal input terminals of the decoder are used to access the n-bit challenge signal C₁-Cₙ, the m output terminals of the decoder are used to output the m-bit word line level signal, the m output terminals of the decoder are connected one-to-one with the m word line level signal input terminals of the PUF core circuit, the first input terminal of the timing circuit accesses the enable signal CEN, the second input terminal is connected to the clock signal CLK, the first output terminal of the timing circuit is connected to the clock signal input terminal of the decoder, the first output terminal of the timing circuit outputs the clock signal AEN, the second output terminal of the timing circuit is connected to the clock signal input terminal of the PUF core circuit, the second output terminal of the timing circuit outputs the clock signal PRE, the power supply terminal of the PUF core circuit is used to access the working supply VDD, the ground terminal of the PUF core circuit is used to connect to the ground voltage VSS, the W output terminals of the PUF core circuit are used to output W-bit PUF responses Z₁-Z_{W}, and the two screening level input terminals of the PUF core circuit are respectively connected to the screening levels V_{L} and V_{R}.

In this embodiment, the PUF core circuit is connected to two screening levels to perform unstable response detection; when the PUF core circuit generates a W-bit PUF response within a certain clock cycle, the m-bit word line level signal received is kept unchanged, and two equal screening levels are connected firstly to generate an original PUF response, and then two unequal screening levels are connected to generate two screened PUF responses; when the two screening levels are not equal, the unstable response value in the original PUF response will flip if there is an unstable response in the original PUF response, the unstable response will flip, so that the corresponding bit value in the W-bit stability mark value obtained after the XOR operation of the two screened PUF responses will be 1 and in this case, if the value of a certain bit in the W-bit stability mark value is 1, it is considered that the response value of this bit in the original PUF response under the current challenge signal is an unstable response; if there is no unstable response in the original PUF response, no flipping will occur at this time, and all bits of the W-bit stability mark value will be completely 0. Therefore, the present disclosure can screen out unstable responses with high stability, and can achieve unstable screening by only connecting two screening levels and causing the two screening levels to be equal and unequal, without the need for additional devices, with low hardware overhead and low detection cost.

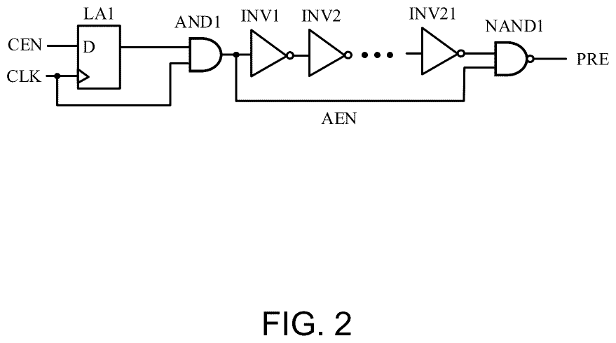

Embodiment 2: This embodiment is basically the same as Embodiment 1 but differs in the following way: in this embodiment, as shown in FIG. 2, the timing circuit comprises a D flip-flop LA1, 21 inverters INV1-INV21, a two-input AND gate AND1 and a first two-input NAND gate NAND1; the D flip-flop LA1 has an input terminal, a clock terminal and an output terminal; the two-input AND gate AND1 has a first input terminal, a second input terminal and an output terminal; the first two-input NAND gate NAND1 has a first input terminal, a second input terminal and an output terminal; the input terminal of the D flip-flop LA1 is connected to the first input terminal of the timing circuit, the clock terminal of the D flip-flop LA1 and the second input terminal of the two-input AND gate AND1, and the connection terminal thereof is the second input terminal of the timing circuit; the output terminal of the D flip-flop LA1 is connected to the first input terminal of the two-input AND gate AND1; the output terminal of the two-input AND gate AND1, the input terminal of the inverter 1 and the second input terminal of the first two-input NAND gate NAND1 are connected, and the connection terminal thereof is the first output terminal of the timing circuit; the output terminal of the inverter k is connected to the input terminal of the inverter k+1 (k=1, 2, . . . , 20), the output terminal of the inverter 21 INV1-INV21 is connected to the first input terminal of the first two-input NAND gate NAND1, and the output terminal of the first two-input NAND gate NAND1 is the second output terminal of the timing circuit.

In this embodiment, when the timing circuit is in working, the enable signal CEN is input into the D flip-flop LA1. Under the control of the clock signal CLK, the D flip-flop LA1 outputs the enable signal CEN through the output terminal thereof in each cycle of the clock signal CLK and in this case, the enable signal CEN and the clock signal CLK are ANDed through the first two-input AND gate AND1 to obtain and output a clock signal AEN. At the same time, the clock signal AEN and a signal obtained by inverting the clock signal AEN in turn through twenty-one inverters INV1-INV21 are NANDed through the first two-input NAND gate NAND1 to obtain and output a clock signal PRE, thereby realizing the overall timing control of the bistable weak PUF circuit with an autonomous stability screening function.

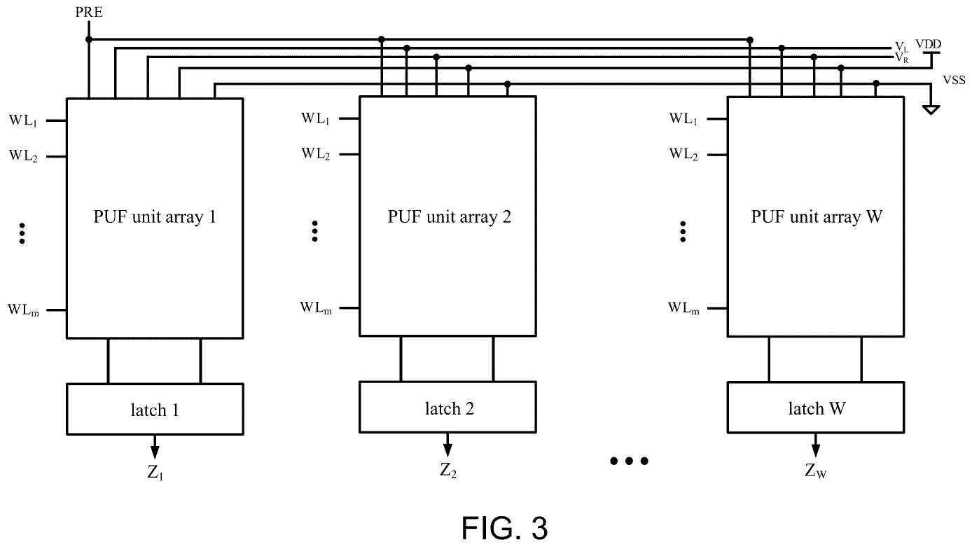

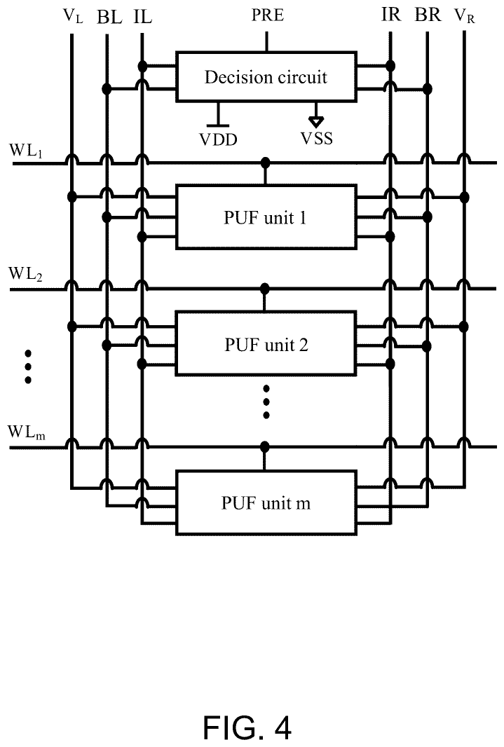

Embodiment 3: This embodiment is basically the same as Embodiment 1 but differs in the following way: in this embodiment, as shown in FIGS. 3 and 4, the PUF core circuit comprises W PUF unit arrays and W latches; each PUF unit array has a power supply terminal, a ground terminal, a clock signal input terminal, m word line level signal input terminals, two screening level input terminals and two output terminals, the two screening level input terminals are respectively designated as first screening level input terminal and second screening level input terminal, and the two output terminals are respectively designated as first output terminal and second output terminal; each latch has two input terminals and one output terminal, the two input terminals are respectively designated as first input terminal and second input terminal; the power supply terminals of the W PUF unit arrays are connected, and the connection terminal thereof is the power supply terminal of the PUF core circuit; the ground terminals of the W PUF unit arrays are connected, and the connection terminal thereof is the ground terminal of the PUF core circuit; the first screening level input terminals of the W PUF unit arrays are connected, and the connection terminal is the first screening level input terminal of the PUF core circuit; the second screening level input terminals of the W PUF unit arrays are connected, and the connection terminal thereof is the second screening level input terminal of the PUF core circuit; the clock signal input terminals of the W PUF unit arrays are connected, and the connection terminal thereof is the clock signal input terminal of the PUF core circuit; the word line level signal input terminals of the W PUF unit arrays are connected, and the connection terminal thereof is the word line level signal input terminal i of the PUF core circuit (i=1, 2, . . . , m); the first output terminal of the PUF unit array b is connected to the first input terminal of the latch b, and the second output terminal of the PUF unit array b is connected to the second input terminal of the latch b (b=1, 2, . . . , W), and the output terminals of the W latches are the W output terminals of the PUF core circuit; each of the PUF unit arrays comprises one decision unit and m PUF units, each PUF unit has one word line level signal input terminal, two screening level input terminals and four output terminals, the four output terminals are respectively designated as first output terminal, second output terminal, third output terminal and fourth output terminal, and the two screening level input terminals are respectively designated as first screening level input terminal and second screening level input terminal; the decision unit has a power supply terminal, a ground terminal, a clock signal input terminal, two input terminals and two output terminals, the two input terminals are respectively designated as first input terminal and second input terminal, and the two output terminals are respectively designated as first output terminal and second output terminal; the word line level signal input terminals of the m PUF units are the m word line level signal input terminals of the PUF unit array, the first screening level input terminals of the m PUF units are connected, and the connection terminal thereof is the first screening level input terminal of the PUF unit array; the second screening level input terminals of the m PUF units are connected, and the connection terminal thereof is the second screening level input terminal of the PUF unit array; the power supply terminal of the decision unit is the power supply terminal of the PUF unit array, the ground terminal of the decision unit is the ground terminal of the PUF unit array, the clock signal input terminal of the decision unit is the clock signal input terminal of the PUF unit array, the first input terminal of the decision unit is connected to the third output terminal of the m PUF units, the second input terminal of the decision unit is connected to the fourth output terminal of the m PUF units, the first output terminal of the decision unit is connected to the first output terminals of the m PUF units, and the connection terminal thereof is the first output terminal of the PUF unit array; the second output terminal of the decision unit is connected to the second output terminals of the m PUF units, and the connection terminal thereof is the second output terminal of the PUF unit array.

In this embodiment, when the PUF core circuit is in working, in the m-bit word line level signal WL₁-WLₘ output by the decoder, only one bit is at a high level, and the remaining m-1 bits are at a low level. In each clock cycle of the clock signal PRE, in each PUF unit array, only one PUF unit connected to the high-level bit of the m-bit word line level signal WL₁-WLₘ is selected and is in a working state, and the other PUF units are not selected and are in a standby state and do not participate in the work. When a PUF unit in the PUF unit array is selected, the clock signal PRE is at a low level, and the decision unit in the PUF unit array enters a charging stage, and the decision unit in the PUF unit array charges the selected PUF unit, so that the first output terminal, the second output terminal, the third output terminal, and the fourth output terminal of the PUF unit are all pre-charged to a high level VDD; and then PRE becomes a high level, and the decision unit in the PUF unit array enters a decision evaluation stage. Due to inevitable random process deviations, the PUF unit has a difference in discharge rate between the first output terminal and the second output terminal, which causes a difference in discharge rate between the first output terminal and the second output terminal of the decision unit. The decision unit further pulls down the signal output by the one with a higher discharge rate in the first output terminal and the second output terminal of the PUF unit to VSS, and pulls up the signal output by the one with a lower discharge rate to close to VDD. The latch connected to the PUF unit determines the signals output by the first output terminal and the second output terminal of the PUF unit to obtain a corresponding PUF response.

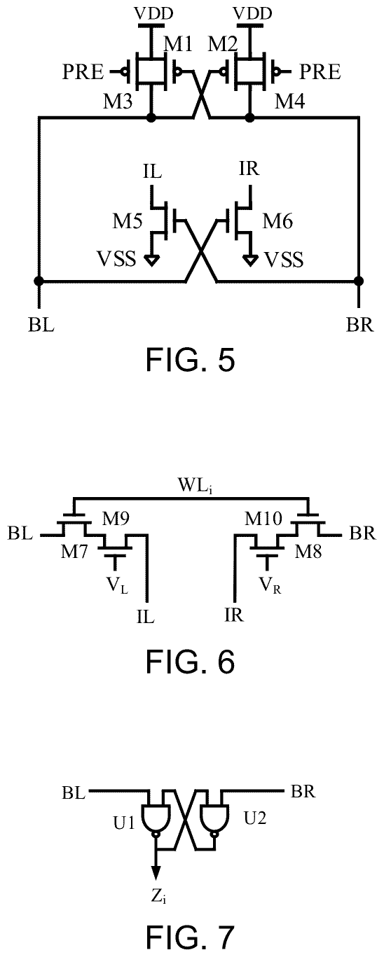

Embodiment 4: This embodiment is basically the same as Embodiment 1 but differs in the following way: in this embodiment, as shown in FIG. 5, the decision unit comprises a first MOS transistor M1, a second MOS transistor M2, a third MOS transistor M3, a fourth MOS transistor M4, a fifth MOS transistor M5 and a sixth MOS transistor M6; the first MOS transistor M1, the second MOS transistor M2, the third MOS transistor M3 and the fourth MOS transistor M4 are PMOS transistors; the fifth MOS transistor M5 and the sixth MOS transistor M6 are NMOS transistors; a source of the first MOS transistor M1, a source of the second MOS transistor M2, a source of the third MOS transistor M3 and a source of the fourth MOS transistor M4 are connected, and the connection terminal thereof is the power supply terminal of the decision unit; a source of the fifth MOS transistor M5 is connected to a source of the sixth MOS transistor M6, and the connection terminal thereof is the ground terminal of the decision unit, a gate of the third MOS transistor M3 is connected to a gate of the fourth MOS transistor M4, and the connection terminal thereof is the clock signal input terminal of the decision unit; a drain of the first MOS transistor M1, a drain of the third MOS transistor M3, a gate of the second MOS transistor M2 and a gate of the sixth MOS transistor M4 are connected, and the connection terminal thereof is the first output terminal of the decision unit; a drain of the second MOS transistor M2, a drain of the fourth MOS transistor M4, a gate of the first MOS transistor M1 and a gate of the fifth MOS transistor M5 are connected, and the connection terminal thereof is the second output terminal of the decision unit; a drain of the fifth MOS transistor M5 is the first input terminal of the decision unit, and a drain of the sixth MOS transistor M6 is the second input terminal of the decision unit.

In this embodiment, when the decision unit is in working, when the clock signal PRE is at a low level, the third MOS transistor M3 and the fourth MOS transistor M4 of the decision unit are both turned on, and the decision unit enters the pre-charging stage, and the voltage values of the first output terminal and the second output terminal of the decision unit gradually increase to VDD, so that the first MOS transistor M1 and the second MOS transistor M2 are both turned off, and the fifth MOS transistor M5 and the sixth MOS transistor M6 are both turned on. When the clock signal PRE is at a high level, the third MOS transistor M3 and the fourth MOS transistor M4 of the decision unit are both turned off, and the decision unit enters a decision evaluation stage. Due to inevitable random process deviations, the PUF unit has a difference in discharge rate between the first output terminal and the second output terminal, which causes a difference in discharge rate between the first output terminal and the second output terminal of the decision unit. The one with a higher discharge rate in the first output terminal and the second output terminal of the decision unit is pulled down to VSS, and the one with a lower discharge rate is pulled up to close to VDD. Specifically, there are the following two cases: if the first output terminal of the decision unit has a higher discharge rate, the second MOS transistor M2 will be the first to be turned on, and the sixth MOS transistor M6 will be the first to be turned off, so that the second output terminal of the decision unit is charged, and the voltage value of the second output terminal of the decision unit will stop falling and gradually increase to close to VDD, and consequently the first MOS transistor M1 is turned off and the fifth MOS transistor M5 is turned on, so that the voltage value of the first output terminal of the decision unit is further pulled down to VSS; if the second output terminal of the decision unit has a higher discharge rate, the first MOS transistor M1 will be the first to be turned on, and the fifth MOS transistor M5 will be the first to be turned off, so that the first output terminal of the decision unit is charged, and the voltage value of the first output terminal of the decision unit will stop falling and gradually increase to close to VDD, and consequently the second MOS transistor M2 is turned off and the sixth MOS transistor M6 is turned on, so that the voltage value of the second output terminal of the decision unit is further pulled down to VSS.

Embodiment 5: This embodiment is basically the same as Embodiment 1 but differs in the following way: in this embodiment, as shown in FIG. 6, each PUF unit comprises a seventh MOS transistor M7, an eighth NMOS transistor, a ninth MOS transistor M9 and a tenth MOS transistor M10, wherein the seventh MOS transistor M7, the eighth NMOS transistor, the ninth MOS transistor M9 and the tenth MOS transistor M10 are NMOS transistors; a drain of the seventh MOS transistor M7 is the first output terminal of the PUF unit, a drain of the eighth MOS transistor M8 is the second output terminal of the PUF unit, a drain of the ninth MOS transistor M9 is the third output terminal of the PUF unit, a drain of the tenth MOS transistor M10 is the fourth output terminal of the PUF unit, a source of the seventh MOS transistor M7 is connected to a source of the ninth MOS transistor M9, a source of the eighth MOS transistor M8 is connected to a source of the tenth MOS transistor M10, a gate of the seventh MOS transistor M7 is connected to a gate of the eighth MOS transistor M8, and the connection terminal thereof is the word line level signal input terminal of the PUF unit; a gate of the ninth MOS transistor M9 is the first screening level input terminal of the PUF unit, and a gate of the tenth MOS transistor M10 is the second screening level input terminal of the PUF unit.

In this embodiment, the PUF unit adopts a twin structure and is composed of only four NMOS transistors of minimum size. By comparing the subthreshold leakage currents of a group of MOS transistors of the same size and symmetrical structure, the final output response is obtained through quantization, thereby further reducing the hardware overhead of the PUF unit.

In this embodiment, the PUF unit determines whether it is selected according to the word line level signal input into the word line level signal input terminal thereof. When the word line level signal input into the word line level signal input terminal is at a low level, the PUF unit is not selected and does not participate in the work. When the word line level signal input into the word line level signal input terminal is at a high level, the PUF unit is selected to participate in the work. When the PUF unit is selected, the PUF unit first enters the charging stage, the seventh MOS transistor M7 and the eighth NMOS transistor are both turned on, the first output terminal, the second output terminal, the third output terminal and the fourth output terminal of the PUF unit are first pre-charged to the high level VDD, and then the PUF unit enters the evaluation stage, the seventh MOS transistor M7 and the eighth NMOS transistor are both turned on. Generally, the screening level VL connected to the first screening level input terminal and the V_{R} connected to the second screening level input terminal are both equal to 325 mV. The first output terminal of the PUF unit is discharged through the seventh MOS transistor M7 and the ninth NMOS transistor M9, and the second output terminal of the PUF unit is discharged through the eighth MOS transistor M8 and the tenth NMOS transistor M10. If screening is required, one of the screening levels V_{L} and V_{R} is kept unchanged, and the other is changed so that the screening level V_{L} is not equal to V_{R} and in this case, the gate voltages of the ninth NMOS transistor M9 and the tenth NMOS transistor M10 are different, resulting in a difference in the conduction degree between the ninth NMOS transistor M9 and the tenth NMOS transistor M10. Consequently, the charge leakage speed of the first output terminal and the second output terminal of the decision unit connected to the PUF unit will be affected not only by the random process deviations of the seventh MOS transistor M7 and the eighth MOS transistor M8, but also by the deviations of the ninth NMOS transistor M9 and the tenth NMOS transistor M10 added artificially. Then the original response (affected only by the random process deviations of the seventh MOS transistor M7 and the eighth MOS transistor M8) is compared with the response with deviation effect added artificially, so as to screen out stable bits and unstable bits.

Embodiment 6: This embodiment is basically the same as Embodiment 1 but differs in the following way: in this embodiment, as shown in FIG. 7, each of the latches comprises two NAND gates, each of the NAND gates has a first input terminal, a second input terminal and an output terminal, and the two NAND gates are respectively designated as first NAND gate U1 and second NAND gate U2; the first input terminal of the first NAND gate U1 is the first input terminal of the latch, the first input terminal of the second NAND gate U2 is the second input terminal of the latch, the second input terminal of the first NAND gate U1 is connected to the output terminal of the second NAND gate U2, the second input terminal of the second NAND gate U2 is connected to the output terminal of the first NAND gate U1, and the connection terminal thereof is the output terminal of the latch.

In this embodiment, when the first input terminal of the latch is connected to a high level and the second input terminal is connected to a low level, the output terminal of the first NAND gate U1 outputs a high level, and the output terminal of the second NAND gate U2 outputs a low level and at this time, the output terminal of the latch outputs a high level. When the second input terminal of the latch is connected to a high level and the first input terminal is connected to a low level, the output terminal of the first NAND gate U1 is reset to a low level, and the output terminal of the second NAND gate U2 outputs a high level and at this time, the output terminal of the latch outputs a low level.

X mV composite screening means that the bistable weak PUF circuit with an autonomous stability screening function, when in working, is placed at the same time at the golden working point (the working environment temperature is 27° C. and the working supply voltage VDD is 1.2V); and 4 extreme working points: the working environment temperature is −40° C. and the working supply voltage VDD is 1.0V; the temperature is −40° C. and the working supply voltage VDD is 1.4V; the temperature is 125° C. and the working supply voltage VDD is 1.0V; and the temperature is 125° C. and the working supply voltage VDD is 1.4V. The same screening operation is performed at the above 5 working points respectively, and X represents the amplitude of the screening level V_{L} or V_{R} reduced relative to 325 mV. Under a certain challenge signal, the first screening level V_{L} is set to 325 mV, and the second screening level V_{R} is set to 325 mV. After the original PUF response is obtained, screening is performed. The specific screening operation is as follows: Step 1: the first screening level V_{L} in all PUF units in the PUF core circuit of the bistable weak PUF circuit with an autonomous stability screening function to 325-X mV, and the second screening level V_{R} is set to 325 mV. In this case, according to the input challenge signal, the decoder outputs an m-bit word line level signal, and the PUF core circuit of the bistable weak PUF circuit with an autonomous stability screening function outputs a first W-bit PUF response value. Step 2: the first screening level V_{L} in the PUF unit in the PUF core circuit of the bistable weak PUF circuit with an autonomous stability screening function is set to 325 mV, and the second screening level V_{R} is set to 325-X mV. In this case, the same challenge signal as that in the first step is given, and the PUF core circuit of the bistable weak PUF circuit with an autonomous stability screening function outputs a second W-bit PUF response value. Step 3: the first W-bit PUF response value is XORed with the second W-bit PUF response value to obtain a W-bit stability mark value. If the value of a certain bit of the W-bit stability mark value is 0, then the corresponding bit of the original PUF response under the challenge signal is determined to be a stable PUF response. If the value of a certain bit of the W-bit stability mark value is 1, then the corresponding bit of the original PUF response under the challenge signal is determined to be a PUF response that is prone to jump.

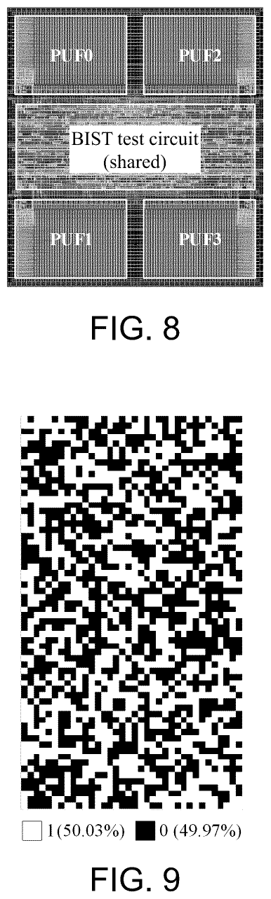

The bistable weak PUF circuit with an autonomous stability screening function according to the present disclosure is implemented using TSMC 65nm process, and the chip layout is shown in FIG. 8. The layout includes four bistable weak PUF circuit with an autonomous stability screening function described herein and one BIST test circuit. The BIST test circuit is mainly used to perform serial-to-parallel and parallel-to-serial conversion on the input and output data of the four bistable weak PUF circuit with an autonomous stability screening function (that is, the BIST test circuit is shared by the four bistable weak PUF circuit with an autonomous stability screening function described herein). The area of the PUF unit is only 1.728 μm², and the feature size of a single PUF unit is only 204.5 F².

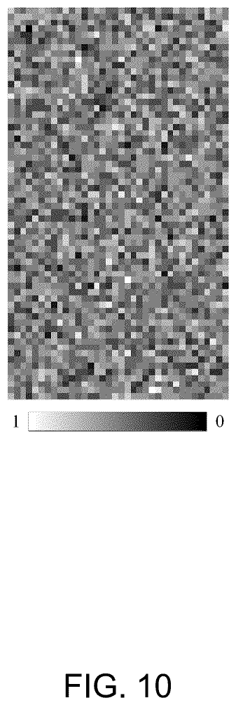

Randomness is an important property of PUF. The output responses of different PUF units are arranged according to their spatial position to form a grayscale matrix to intuitively observe the distribution of 0 and 1 of the output responses. FIG. 9 is a grayscale image of output PUF responses of a randomly selected individual bistable weak PUF circuit with an autonomous stability screening function, in which white pixels and black pixels are used to mark responses 1 and 0, respectively. Referring to FIG. 9, the probabilities of “1” and “0” in the response are 50.03% and 49.97%, respectively, which are close to the ideal value of 50%. The average grayscale image of the response bits of ten individual bistable weak PUF circuits with an autonomous stability screening function according to the present disclosure is shown in FIG. 10. Referring to FIG. 10, the grayscale values are concentrated around 0.5, and no obvious spatial artifacts are observed. It can be seen that the bistable weak PUF circuits with an autonomous stability screening function according to the present disclosure has good randomness.

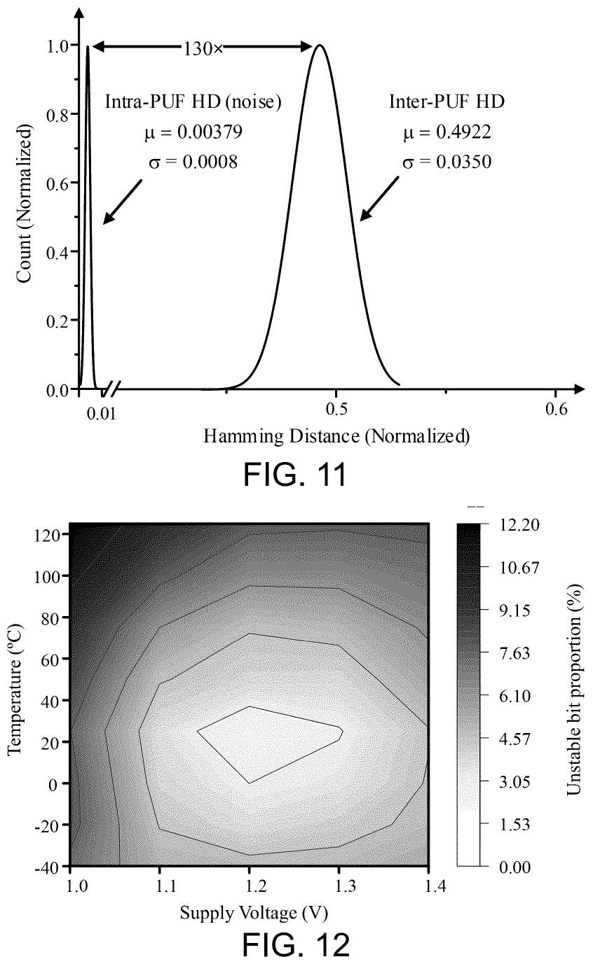

Reliability is an extremely important performance indicator of PUF and is usually measured by the intra-chip Hamming distance. The intra-chip Hamming distance is the statistical characteristic of the response change of the same PUF circuit individual under the same challenge signal in different environments. The diagram of the normalized inter-chip Hamming distance and intra-chip Hamming distance of the bistable weak PUF circuit with an autonomous stability screening function according to the present disclosure is shown in FIG. 11. According to FIG. 11, the bistable weak PUF circuit with an autonomous stability screening function according to the present disclosure has the average intra-chip Hamming distance of 0.00379 and the reliability of 99.6%. In addition, as shown in FIG. 11, the ratio of HDᵢₙₜₑᵣ to HDᵢₙₜᵣₐ of the bistable weak PUF circuit with an autonomous stability screening function according to the present disclosure exceeds 130, indicating that the bistable weak PUF circuit with an autonomous stability screening function has good recognition.

In order to characterize the stability of the output response of the bistable weak PUF circuit with an autonomous stability screening function according to the present disclosure, the bistable weak PUF circuit with an autonomous stability screening function according to the present disclosure is read repeatedly 100 times at different temperatures and voltages to obtain the statistical results of the bit error rate (BER) and unstable bit proportion of the output responses at different temperatures and voltages. The original unstable bit proportion diagram of the bistable weak PUF circuit with an autonomous stability screening function according to the present disclosure in the range of −40° C.-125 ° C., 1.0V-1.4V is shown in FIG. 12. Referring to FIG. 12, when the voltage changes within the range of 1.0V to 1.4V and the temperature changes within the range of −40° C. to 125° C., the maximum bit error rate (unstable bit proportion) of the output response of the bistable weak PUF circuit with an autonomous stability screening function according to the present disclosure is 10.62% (12.17%) @1.0V/125° C., which shows that the output response of the bistable weak PUF circuit with an autonomous stability screening function according to the present disclosure has good robustness.

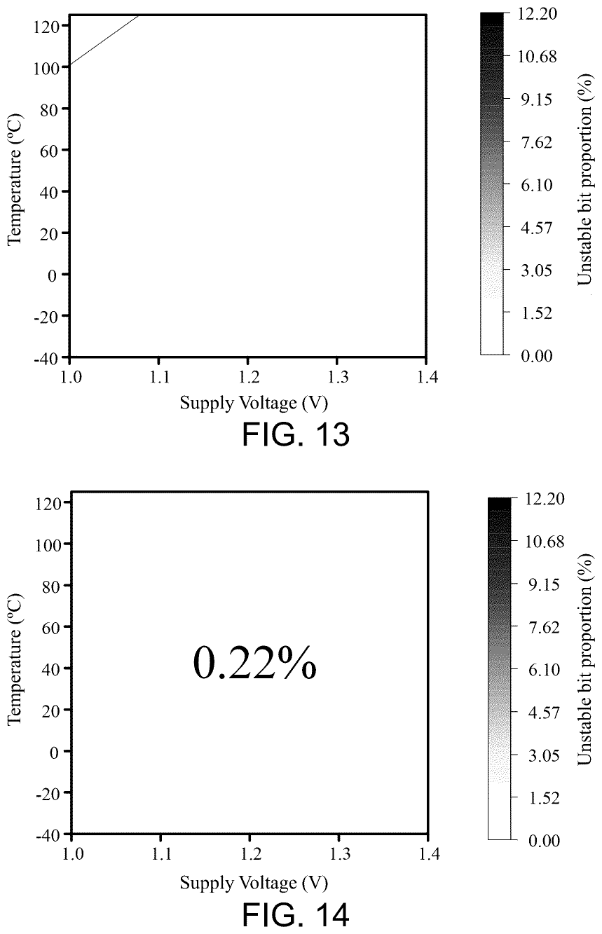

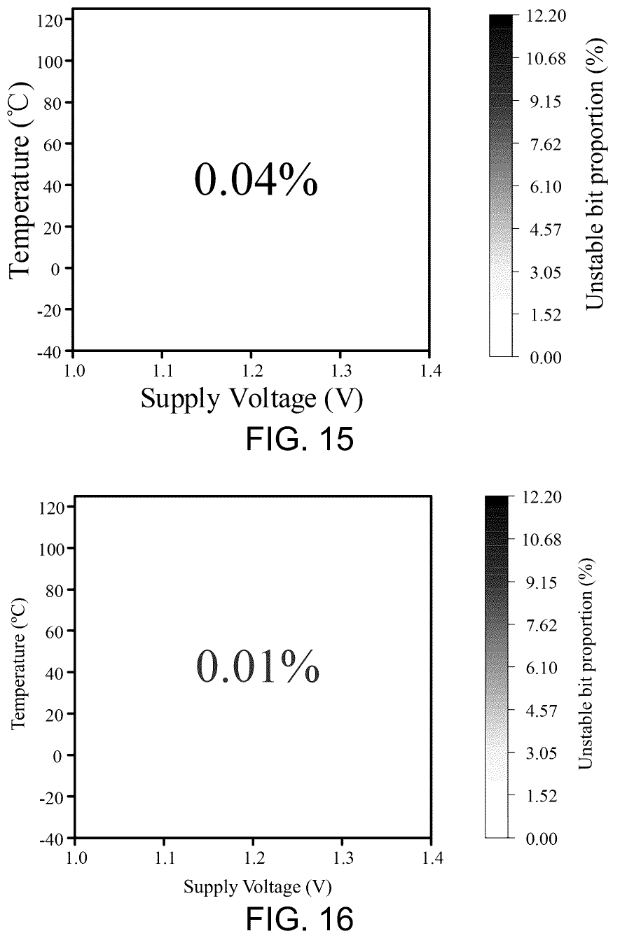

The bistable weak PUF circuit with an autonomous stability screening function according to the present disclosure was subjected to four X mV composite screenings. In the three X mV composite screenings, X mV was 5 mV, 10 mV, 15 mV and 20 mV respectively. The unstable bit proportion diagram of the PUF response of the bistable weak PUF circuit with an autonomous stability screening function according to the present disclosure after 5 mV composite screening is shown in FIG. 13. The unstable bit proportion diagram of the PUF response of the bistable weak PUF circuit with an autonomous stability screening function according to the present disclosure after 10 mV composite screening is shown in FIG. 14. The unstable bit proportion diagram of the PUF response of the bistable weak PUF circuit with an autonomous stability screening function according to the present disclosure after 15 mV composite screening is shown in FIG. 15. The unstable bit proportion diagram of the PUF response of the bistable weak PUF circuit with an autonomous stability screening function according to the present disclosure after 20 mV composite screening is shown in FIG. 16.

Referring to FIG. 13, after 5 mV composite screening, the maximum unstable bit proportion of the PUF output response of the bistable weak PUF circuit with an autonomous stability screening function according to the present disclosure is reduced to 2.21%. Referring to FIG. 14, after 10 mV composite screening, the maximum unstable bit proportion of the PUF output response of the bistable weak PUF circuit with an autonomous stability screening function according to the present disclosure is reduced to 0.22%. Referring to FIG. 15, after 15 mV composite screening, the maximum unstable bit proportion of the PUF output response of the bistable weak PUF circuit with an autonomous stability screening function according to the present disclosure is reduced to 0.04%. Referring to FIG. 16, after 20 mV composite screening, the maximum unstable bit proportion of the PUF output response of the bistable weak PUF circuit with an autonomous stability screening function according to the present disclosure is reduced to 0.01%. It can be seen that the bistable weak PUF circuit with an autonomous stability screening function according to the present disclosure has high stability.

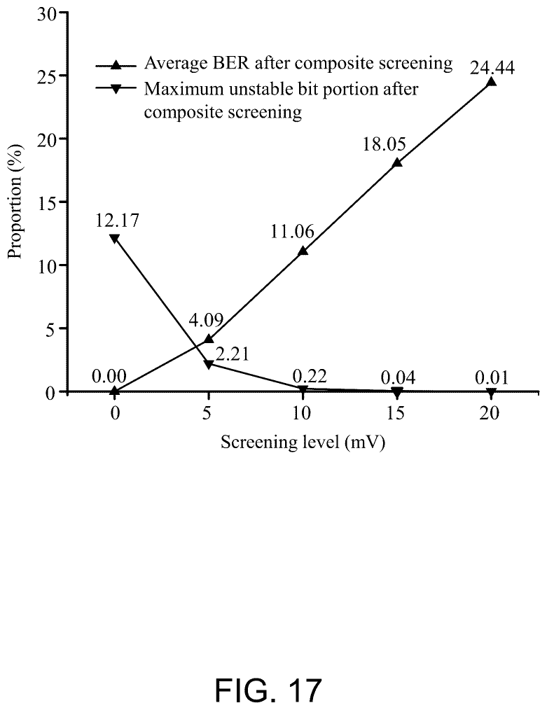

In order to evaluate the screening efficiency of the bistable weak PUF circuit with an autonomous stability screening function according to the present disclosure, in addition to paying attention to the proportion of unstable bits after screening, it is also necessary to pay attention to the proportion of originally stable bits marked as unstable bits, namely, the false screening rate. The unstable bit proportion diagram of the PUF response of the bistable weak PUF circuit with an autonomous stability screening function according to the present disclosure after composite screening with different screening levels is shown in FIG. 17. With reference to FIG. 17, the average false screening rate of the bistable weak PUF circuit with an autonomous stability screening function according to the present disclosure is 24.44% when performing 20 mV composite screening, and the maximum unstable bit proportion is 0.01%. It can be seen that the bistable weak PUF circuit with an autonomous stability screening function according to the present disclosure has high screening efficiency.

In summary, the bistable weak PUF circuit with an autonomous stability screening function according to the present disclosure can achieve unstable bit screening by only connecting two screening levels and causing the two screening levels equal and unequal, without the need for additional devices, with low hardware overhead and low detection cost. Through MPW tape-out using TSMC 65 nm CMOS process, the total area of the PUF core circuit is 4455 μm², and the single-bit feature size is only 204.5 F². The chip test results show that the bistable weak PUF circuit with an autonomous stability screening function according to the present disclosure has good randomness (50.03%), uniqueness (48.8%), and reliability (99.6%). When the temperature changes between −40° C. and 125° C. and the voltage changes between 1.0V and 1.4V, the maximum unstable bit proportion can be reduced from 12.17% to nearly 0 (less than 1×10⁻⁴) by using the X mV composite screening strategy. The bistable weak PUF circuit with an autonomous stability screening function according to the present disclosure has outstanding performance in hardware overhead, stability and the like, and is very suitable for security protection of IoT.

What is claimed is:

1. A bistable weak PUF circuit with an autonomous stability screening function, comprising:
a decoder, wherein the decoder is configured to access an n-bit challenge signal C₁-Cₙ, and configured to perform a decoding operation on the n-bit challenge signal C₁-Cₙ to obtain an m-bit word line level signal WL₁-WLₘ, and the decoder is further configured to output the m-bit word line level signal WL₁-WLₘ to a PUF core circuit, where n is an integer greater than or equal to 1, and m=2ⁿ;
a timing circuit, wherein the timing circuit is configured to access a clock signal CLK and an enable signal CEN, and configured to perform an AND operation on the clock signal CLK and the enable signal CEN to obtain a clock signal AEN for controlling the working timing of the decoder, and configured to output the clock signal AEN to the decoder, wherein the timing circuit is further configured to delay and invert the clock signal AEN and perform an NAND operation on the clock signal AEN to obtain a clock signal PRE for controlling the working timing of the PUF core circuit, and configured to output the clock signal PRE to the PUF core circuit; and
the PUF core circuit, wherein the PUF core circuit is configured to generate a W-bit PUF response in each clock cycle of the clock signal PRE under the control of the m-bit word line level signal output by the decoder, where W is an integer greater than or equal to 1;
wherein the PUF core circuit has an autonomous stable bit screening function, and the PUF core circuit is configured to realize stable bit screening by connecting two screening levels;
wherein when the two screening levels connected to the PUF core circuit are equal, the PUF core circuit generates a W-bit PUF response in one clock cycle of the clock signal PRE under the control of the m-bit word line level signal output by the decoder as an original PUF response of the clock cycle;
then, the m-bit word line level signal received by the PUF core circuit is kept unchanged, one of the two screening levels connected to the PUF core circuit is kept unchanged, and the other is reduced by a certain amplitude, and the W-bit PUF response generated within a clock cycle of the clock signal PRE is used as a first screened PUF response;
then, the two screening levels are exchanged, the W-bit PUF response generated within one clock cycle of the clock signal PRE is used as a second screened PUF response;
wherein the first screened PUF response and the second screened PUF response are XORed with each other to obtain a W-bit stability mark value;
if a value of a bit in the W-bit stability mark value is 1, it is considered that a response value of the bit in the original PUF response under the current challenge signal is an unstable response.

2. The bistable weak PUF circuit with the autonomous stability screening function according to claim 1, wherein
the decoder has n challenge signal input terminals, a clock signal input terminal, and m output terminals;
the timing circuit has two input terminals and two output terminals, the two input terminals are respectively designated as first input terminal and second input terminal, the two output terminals of the timing circuit are respectively designated as first output terminal and second output terminal;
the PUF core circuit has a power supply terminal, a ground terminal, m word line level signal input terminals, one clock signal input terminal, two screening level input terminals, and W output terminals;
the n challenge signal input terminals of the decoder are configured to access the n-bit challenge signal C₁-Cₙ, the m output terminals of the decoder are configured to output the m-bit word line level signal, the m output terminals of the decoder are connected one-to-one with the m word line level signal input terminals of the PUF core circuit;
the first input terminal of the timing circuit is configured to access the enable signal CEN, the second input terminal of the timing circuit is connected to the clock signal CLK, the first output terminal of the timing circuit is connected to the clock signal input terminal of the decoder, the first output terminal of the timing circuit is configured to output the clock signal AEN, the second output terminal of the timing circuit is connected to the clock signal input terminal of the PUF core circuit, the second output terminal of the timing circuit is configured to output the clock signal PRE;
the power supply terminal of the PUF core circuit is configured to access the working supply VDD, the ground terminal of the PUF core circuit is connected to the ground voltage VSS, the W output terminals of the PUF core circuit are configured to output W-bit PUF responses Z₁-Z_{W}, and the two screening level input terminals of the PUF core circuit are respectively connected to the screening levels V_{L} and V_{R}.

3. The bistable weak PUF circuit with the autonomous stability screening function according to claim 2, wherein the timing circuit comprises a D flip-flop, twenty-one inverters, a two-input AND gate and a first two-input NAND gate;
the D flip-flop has an input terminal, a clock terminal and an output terminal;
the two-input AND gate has a first input terminal, a second input terminal, and an output terminal;
the first two-input NAND gate has a first input terminal, a second input terminal, and an output terminal;
the input terminal of the D flip-flop is connected to the first input terminal of the timing circuit, the clock terminal of the D flip-flop and the second input terminal of the two-input AND gate, and a connection terminal thereof is the second input terminal of the timing circuit;
the output terminal of the D flip-flop is connected to the first input terminal of the two-input AND gate;
the output terminal of the two-input AND gate, an input terminal of the first inverter of the twenty-one inverters and the second input terminal of the first two-input NAND gate are connected with each other, and a connection terminal thereof is the first output terminal of the timing circuit;
an output terminal of the kth inverter is connected to an input terminal of the (k+1)th inverter, wherein k is a positive integer from 1 to 20,
an output terminal of the twenty-first inverter is connected to the first input terminal of the first two-input NAND gate, and the output terminal of the first two-input NAND gate is the second output terminal of the timing circuit.

4. The bistable weak PUF circuit with the autonomous stability screening function according to claim 2, wherein
the PUF core circuit comprises W PUF unit arrays and W latches;
each of the PUF unit arrays has a power supply terminal, a ground terminal, a clock signal input terminal, m word line level signal input terminals, two screening level input terminals, and two output terminals;
the two screening level input terminals are respectively designated as first screening level input terminal and second screening level input terminal, and the two output terminals are respectively designated as first output terminal and second output terminal;
each of the W latches has two input terminals and one output terminal, the two input terminals are respectively designated as first input terminal and second input terminal;
the power supply terminals of the W PUF unit arrays are connected with each other, and a connection terminal thereof is the power supply terminal of the PUF core circuit; the ground terminals of the W PUF unit arrays are connected with each other, and a connection terminal thereof is the ground terminal of the PUF core circuit;
the first screening level input terminals of the W PUF unit arrays are connected with each other, and a connection terminal is the first screening level input terminal of the PUF core circuit; the second screening level input terminals of the W PUF unit arrays are connected with each other, and a connection terminal thereof is the second screening level input terminal of the PUF core circuit;
the clock signal input terminals of the W PUF unit arrays are connected with each other, and a connection terminal thereof is the clock signal input terminal of the PUF core circuit; the word line level signal input terminals of the W PUF unit arrays are connected with each other, and a connection terminal thereof is a word line level signal input terminal i of the m word line level signal input terminals of the PUF core circuit, wherein I is a positive integer from 1 to m;
a first output terminal of a PUF unit array b of the W PUF unit arrays is connected to a first input terminal of a latch b of the W latches, and a second output terminal of the PUF unit array b is connected to a second input terminal of the latch b, wherein b is a positive integer from 1 to W, and the output terminals of the W latches are the W output terminals of the PUF core circuit;
each of the W PUF unit arrays comprises one decision unit and m PUF units, each of the m PUF units has one word line level signal input terminal, two screening level input terminals, and four output terminals, wherein the four output terminals are respectively designated as first output terminal, second output terminal, third output terminal, and fourth output terminal, and the two screening level input terminals are respectively designated as first screening level input terminal and second screening level input terminal;
the decision unit has a power supply terminal, a ground terminal, a clock signal input terminal, two input terminals, and two output terminals, wherein the two input terminals are respectively designated as first input terminal and second input terminal, and the two output terminals are respectively designated as first output terminal and second output terminal;
the word line level signal input terminals of the m PUF units are the m word line level signal input terminals of the PUF unit array, the first screening level input terminals of the m PUF units are connected with each other, and a connection terminal thereof is the first screening level input terminal of the PUF unit array;
the second screening level input terminals of the m PUF units are connected with each other, and a connection terminal thereof is the second screening level input terminal of the PUF unit array;
the power supply terminal of the decision unit is the power supply terminal of the PUF unit array, the ground terminal of the decision unit is the ground terminal of the PUF unit array, the clock signal input terminal of the decision unit is the clock signal input terminal of the PUF unit array, the first input terminal of the decision unit is connected to the third output terminal of the m PUF units, the second input terminal of the decision unit is connected to the fourth output terminal of the m PUF units, the first output terminal of the decision unit is connected to the first output terminals of the m PUF units, and a connection terminal thereof is the first output terminal of the PUF unit array;
the second output terminal of the decision unit is connected to the second output terminals of the m PUF units, and a connection terminal thereof is the second output terminal of the PUF unit array.

5. The bistable weak PUF circuit with the autonomous stability screening function according to claim 4, wherein
the decision unit comprises a first MOS transistor, a second MOS transistor, a third MOS transistor, a fourth MOS transistor, a fifth MOS transistor, and a sixth MOS transistor;
the first MOS transistor, the second MOS transistor, the third MOS transistor, and the fourth MOS transistor are PMOS transistors; the fifth MOS transistor and the sixth MOS transistor are NMOS transistors;
a source of the first MOS transistor, a source of the second MOS transistor, a source of the third MOS transistor, and a source of the fourth MOS transistor are connected with each other, and a connection terminal thereof is the power supply terminal of the decision unit; a source of the fifth MOS transistor is connected to a source of the sixth MOS transistor, and a connection terminal thereof is the ground terminal of the decision unit, a gate of the third MOS transistor is connected to a gate of the fourth MOS transistor, and a connection terminal thereof is the clock signal input terminal of the decision unit;
a drain of the first MOS transistor, a drain of the third MOS transistor, a gate of the second MOS transistor, and a gate of the sixth MOS transistor are connected with each other, and a connection terminal thereof is the first output terminal of the decision unit;
a drain of the second MOS transistor, a drain of the fourth MOS transistor, a gate of the first MOS transistor, and a gate of the fifth MOS transistor are connected with each other, and a connection terminal thereof is the second output terminal of the decision unit; a drain of the fifth MOS transistor is the first input terminal of the decision unit, and a drain of the sixth MOS transistor is the second input terminal of the decision unit.

6. The bistable weak PUF circuit with the autonomous stability screening function according to claim 4, wherein
each of the m PUF units comprises a seventh MOS transistor, an eighth NMOS transistor, a ninth MOS transistor, and a tenth MOS transistor, wherein the seventh MOS transistor, the eighth NMOS transistor, the ninth MOS transistor, and the tenth MOS transistor are NMOS transistors; a drain of the seventh MOS transistor is the first output terminal of the PUF unit, a drain of the eighth MOS transistor is the second output terminal of the PUF unit, a drain of the ninth MOS transistor is the third output terminal of the PUF unit, a drain of the tenth MOS transistor is the fourth output terminal of the PUF unit;
a source of the seventh MOS transistor is connected to a source of the ninth MOS transistor, a source of the eighth MOS transistor is connected to a source of the tenth MOS transistor, a gate of the seventh MOS transistor is connected to a gate of the eighth MOS transistor, and the connection terminal thereof is the word line level signal input terminal of the PUF unit;
a gate of the ninth MOS transistor is the first screening level input terminal of the PUF unit, and a gate of the tenth MOS transistor is the second screening level input terminal of the PUF unit.

7. The bistable weak PUF circuit with the autonomous stability screening function according to claim 4, wherein
each of the W latches comprises two NAND gates, each of the two NAND gates has a first input terminal, a second input terminal and an output terminal, and the two NAND gates are respectively designated as first NAND gate and second NAND gate;
the first input terminal of the first NAND gate is the first input terminal of the latch, the first input terminal of the second NAND gate is the second input terminal of the latch, the second input terminal of the first NAND gate is connected to the output terminal of the second NAND gate, the second input terminal of the second NAND gate is connected to the output terminal of the first NAND gate, and a connection terminal thereof is the output terminal of each of the W latches.
